(19) United States
(12) Patent Application Publication
(10) Pub. No.: US 2022/0403824 A1
(43) Pub. Date: Dec. 22, 2022

(54) OBTAINING INSTRUCTIONS WITHIN A WIND POWER PLANT PRIVATE NETWORK

(71) Applicant: VESTAS WIND SYSTEMS A/S, Aarhus N. (DK)

(72) Inventors: Anders REIMER, Hadsten (DK); Morten Tim THORSEN, Tilst (DK); Jan Krogh JENSEN, Hinnerup (DK); Peter TROJEL, Åbyhøj (DK)

(21) Appl. No.: 17/774,458

(22) PCT Filed: Oct. 27, 2020
(86) PCT No.: PCT/DK2020/050293

§ 371 Date: May 4, 2022

(30) Foreign Application Priority Data
Nov. 4, 2019 (DK) PA 2019 70678

(51) Int. Cl. F03D 7/04

(52) U.S. Cl. CPC F03D 7/047; F03D 7/048

(57) ABSTRACT

Obtaining within a private network of a power plant one or more instructions for controlling the power plant, wherein the power plant includes one or more wind turbine generators, and wherein one or more instructions for controlling the power plant are received at an external digital storage device placed externally with respect to the private network. The one or more instructions are stored in a queue in the external digital storage device. The one or more instructions are fetched from the queue independent with respect to events initiated externally with respect to the private network.

### FIELD OF THE INVENTION

The invention relates to a method for obtaining data within a private network, and more particularly to a method for fetching instructions into a private network of a wind power plant and a corresponding system and computer program product.

### BACKGROUND OF THE INVENTION

While it may be beneficial that a power plant can obtain, e.g. within a private network, digital instructions for controlling the power plant from parties external to the power plant, a connection for conveying digital information and enabling obtaining digital instructions from external parties may generally be associated with a security risk.

Disconnecting the connection for conveying digital information might eliminate or reduce the security risk, but is likely associated with negative consequences in terms of, e.g., reduced energy production, increased risk of wear and/or malfunctioning, increased time consumption for controlling the power plant, etc., due to the lacking possibility of obtaining at the power plant digital instructions for controlling the power plant from parties external to the power plant.

Hence, an improved method for obtaining within a private network of a power plant instructions for controlling the power plant would be advantageous, and in particular a method which eliminates or reduces a security risk and/or eliminates or reduces negative consequences in the form of reduced energy production, increased risk of wear and/or malfunctioning and increased time consumption for controlling the power plant.

### SUMMARY OF THE INVENTION

It may be seen as an object of the present invention to provide an improved method for obtaining within a private network of a power plant instructions for controlling the power plant, and in particular a method which eliminates or reduces a security risk and/or eliminates or reduces negative consequences in the form of reduced energy production, increased risk of wear and/or malfunctioning and increased time consumption for controlling the power plant.

Thus, the above described object and several other objects are intended to be obtained in a first aspect of the invention by providing a method for obtaining within a private network of a power plant one or more instructions for controlling the power plant, wherein the power plant is comprising one or more wind turbine generators, and wherein the method is comprising:
Receiving at an external digital storage device placed externally with respect to the private network one or more instructions for controlling the power plant,
Storing the one or more instructions in a queue in the external digital storage device,
Obtaining within the private network on request from within the private network one or more instructions for controlling the power plant, wherein said obtaining includes that one or more devices within the private network are fetching from the queue in the external digital storage device said one or more instructions for controlling the power plant stored in the queue in the external digital storage device, wherein said fetching is independent with respect to events initiated externally with respect to the private network.

The invention may be seen as particularly, but not exclusively, advantageous for obtaining a method for obtaining securely within a private network of a power plant instructions for controlling the power plant. Security is realized due to the instructions being fetched independently with respect to any event initiated externally with respect to the private network, i.e., no instructions are sent or pushed into the private network and it is consequently not possible for external parties (by fault or with ill intentions) to send or push instructions entailing negative consequences. In other words, with the use of independently is meant that the fetching of instructions is done independently of instructions, orders and/or wishes external to the private network.

The invention may alternatively and/or additionally be seen as particularly, but not exclusively, advantageous for providing a method which eliminates or reduces negative consequences in the form of reduced energy production, increased risk of wear and/or malfunctioning and increased time consumption for controlling the power plant. These negative consequences may be realized by allowing external control via the secure independent fetching, which may in turn facilitate a relatively high energy production (e.g., due to effectively avoiding down time and/or enabling optimized operation via instructions from one or more external parties), reducing a risk of wear and/or malfunction (e.g., due to effectively aborting or modifying damaging operation via instructions from one or more external parties) and reducing time consumption for controlling the power plant (e.g., due to delegation of operation to one or more efficient external expert parties and or due to avoiding a time consuming process of obtaining physical access via instructions from one or more external parties fetched into the private network).

‘Private network’ is understood as is common in the art and particularly as a network wherein restrictions are established to promote a secured environment, such wherein devices outside the private network cannot access it except via a selected strict subset of devices (which may be referred to as ‘access point(s)’), such as devices placed in a secured network environment, such as a demilitarized zone (DMZ). A private network is understood to inherently comprise a plurality of devices (such as processors, computers, servers and/or clients) which are connected to each other in the private network.

‘Power plant’ is understood as is common in the art, and in particular as an entity capable of producing power, such as capable of (rated for) a production of at least 0.1 megawatt (MW), such as at least 1.0 MW, such as at least 10 MW. The power plant comprises one or more wind turbine generators (wherein a wind turbine generator may be abbreviated ‘WTG’ and is used interchangeably with ‘wind turbine’ which is generally known in the art), such as one or more horizontal axis wind turbines optionally each rated for at least 0.1 MW, and may in that case be referred to as wind power plant (WPP), and in case of the wind power plant comprising a plurality of wind turbines, it may be referred to as wind farm or wind park.

By ‘instruction for controlling the power plant’ may be understood a set of data comprising at least a command for controlling the power plant, such as controlling an asset in the power plant and/or for controlling an operational parameter of the power plant. The ‘instruction’ may furthermore comprise additional data, such as data regarding an update and/or (timestamp-)data comprising a time of receipt at an external digital storage device and/or information addressing an asset to be controlled according to the command (e.g., which wind turbine in a wind park is to have its rotor speed changed to a certain value).

A ‘command’ may be understood as an information regarding one or more actions to be taken.

By ‘operational parameters’ (used interchangeably with ‘parameter’) may be understood parameters relevant for operation of the power plant, such as for operation of the one or more wind turbine generators. Some operational parameters may be controllable, for example ‘pitch angle’ (for a wind turbine with controllable pitch angle), whereas others may be given (i.e., be uncontrollable) under certain circumstances, for example ‘wind speed’. Some operational parameters may be qualitative (e.g., wind turbine shut down [yes/no]) or qualitative (e.g., rotor speed [rounds per minute (RPM)]).

In general, a ‘parameter’ may be representative of a data type, such as ‘wind speed’ or ‘pitch angle’, whereas ‘(parameter) value’ may be the actual value, such as ‘10 m/s’ or ‘10 degrees’.

The command may be a super-command encompassing a plurality of (sub-)commands, e.g., in case the (super-)command is information about which actions (according to (sub-)commands) are to be taken upon various conditions, e.g., where the command relates to implementation of another controlling scheme, e.g., in case the power plant is to be instructed to operate according to a safe mode. The command may alternatively specifically be an action relating to a specific operational parameter (e.g., an adjustment or rotor speed). The command may be qualitative (e.g., ‘shut down’/‘start up’ or switching a setting on/off) or quantitative (e.g., adjusting a parameter by a certain numerical amount), The command may relate to forward or feedback control (e.g., changing an input parameter, e.g., a certain voltage setting, or changing a first operational parameter by an amount so that a second operational parameter approaches a target value).

An ‘asset’ may be understood to be an apparatus, unit or device, such as within the power plant, such as a wind turbine or a part thereof or another part of the power plant, such as a transformer. An ‘asset’ may or may not be controllable via the private network.

By a ‘digital storage device’ is understood any device capable of storing digital instructions, such as a hard disk drive (HDD) or a server. The external digital storage device may in particular be a server.

By the ‘(external) digital storage device placed externally with respect to the private network’ is understood that it is placed outside and/or at the perimeter of the private network and that access to the (external) digital storage device can be achieved without achieving access to the private network.

The ‘external digital storage device’ is placed operatively connected to the private network, such as to an access point of the private network, such as in a secured network environment, such as in a demilitarized zone of the private network. It may furthermore be understood that the ‘external digital storage device’ is placed operatively connected to the public Internet, such as in a demilitarized zone of the private network. In embodiments, the ‘external digital storage device’ is placed in a secured network environment such as in a demilitarized zone of the private network, yet accessible from the public internet.

By ‘(storing in a) queue’ is understood that the instructions are stored in a sequence determining the sequence in which they are handled. For example, the sequence of the instructions in the queue determines the sequences in which the instructions are fetched into the private network and optionally the sequence in which they are handled within the private network, such as by ‘(storing in a) queue’ is understood that the instructions are stored in the order in which they are handled, for example according to the First In First Out (FIFO) principle.

By ‘obtaining’ is understood that the one or more devices, such as a processor, fetches (i.e., retrieves, such as actively retrieves, as opposed to receiving) from the queue in the external digital storage device said one or more instructions for controlling the power plant stored in the queue in the external digital storage device. This is done on request, such as exclusively on request from within the private network, such as from one or more devices within the private network.

By ‘on request’ may be understood that a time of (onset) of fetching is determined exclusively within the private network, such a by one or more devices within the private network. This may ensure autonomous operation, i.e., may guarantee zero interference from external parties insofar as when to obtain instructions.

It is furthermore understood that the fetching is ‘independent’ with respect to events (such as instructions, orders, requests and/or wishes) initiated externally with respect to the private network, i.e., not only is the fetching initiated autonomously, it is also carried out autonomously. This may ensure autonomous operation, i.e., may guarantee zero interference from external parties insofar as how to obtain instructions.

It may be seen as a basic insight of the present inventors that security can be increased or safeguarded while still enabling obtaining instructions from external parties by arranging devices within the private network of the power plant to autonomously fetch data placed in an (external) digital storage device placed externally to the private network.

According to an embodiment the method is further comprising subjecting within the private network, such as subsequent to said obtaining within the private network one or more instructions for controlling the power plant, the one or more instructions for controlling the power plant obtained within the private network to a step of approval or rejection. This may be seen as an additional layer of security. The step may be carried out by a device, such as a processor or a server, within the private network. The step may be based on one or more of the command of the instruction, the source of the instruction and the time of receipt of the instruction and/or the temporal distribution of a plurality of instructions.

According to an embodiment the step of approval or rejection comprises validating the command of the one or more instructions. A validation of a command for example examines if the command is eligible for the power plant, such as if it relates to controllable assets within the power plant (e.g., a command requesting a change of pitch angle would not be eligible for a power plant with no wind turbines having pitchable blades) or if a requested value is outside of a range of eligible values (e.g., if a wind turbine with a rated power production of 1 MW is requested to produce 20 MW). A (step of) validation of a command may additionally or alternatively check if the command is inappropriate and deem it inappropriate if it would entail a relative change of a value outside an acceptable range or if it has never been issued before (even if it is eligible for the power plant).

According to an embodiment an instruction is rejected due to a lack of validation if the command of the instruction is not on a predefined list of commands. This may be beneficial for increasing security. The list of commands on the predefined list of commands may form a set consisting of all applicable commands for controlling the power plant. The list of commands on the predefined list of commands may (alternatively) form a proper subset of commands applicable for controlling the power plant, such as wherein the predefined list of commands excludes potentially harmful and/or detrimental commands.

According to an embodiment the step of approval or rejection comprises verifying that the one or more instructions originate from a trusted source. This may be beneficial for increasing security, e.g., due to enabling rejecting instructions from non-trusted sources, which are likely to be associated with a higher risk of being malicious. ‘Verifying’ is understood as is common in the art, such as checking if data representative of a source can be tied to a trusted source. A source may be a trusted source if it is on a predefined list of trusted source, if it is of a certain type of sources or if it belongs to a certain group of sources, According to an embodiment an instruction is rejected due to a lack of verification if the source is not on a predefined list of trusted sources. An advantage of having a predefined list of trusted sources may be that it facilitates in an expedient manner excluding non-trusted sources, which may in turn in an expedient manner increase security.

According to an embodiment, optionally in combination with the above mentioned step of approval or rejection comprising verifying that the one or more instructions originate from a trusted source, the step of approval or rejection (furthermore) comprises authenticating that the one or more instructions originate from a trusted source. This may increase security. ‘Authenticating’ is understood as is common in the art, such as wherein an identity of a (trusted) source is checked via something that only the allegedly trusted source should have or know, e.g., a password, such as a one-time-password (OTP) and/or via a digital signature (also known as a cryptographic signature).

According to an embodiment said fetching is halted if one or more predefined criteria are determined within the private network, such as determined by one or more devices within the private network, to be fulfilled. This may increase security, e.g., due to halting of the fetching if suspicious activity is suspected (such as wherein fulfilment of the predefined criteria may be seen as an indication of suspicious activity), which may in turn prevent fetching and execution of (later) potentially malicious instructions, even if the (later) instructions in themselves might not have triggered a fulfilment of the criteria or a rejection.

According to a further embodiment the one or more predefined criteria are determined to be fulfilled if one or more of the following corresponding, such as wherein each predefined criterion corresponds to a corresponding condition, conditions are determined to be true:
The step of approval or rejection results in a rejection,
The step of validation of command results in a rejection due to a lack of validation,
The step of verification results in a rejection due to a lack of verification,
A temporal distribution of time of receipt of the one or more instructions at the external digital storage device is not acceptable,
A number, such as 2 or 11 or 101 or 1001, of instructions received at the external digital storage device exceeds a first predetermined number, such as 1 or 10 or 100 or 1000, of instructions within a first predetermined period of time, such as 1 second, 1 minute or 1 hour or 1 day, such as wherein more than 10 instructions are received within 1 second,
A number of instructions, such as 2 or 6 or 11 or 101 or 1001, addressing assets which are not subject to control via the private network and received at the external digital storage device exceeds a second predetermined number, such as 1 or 5 or 10 or 100 or 1000, of instructions within a second predetermined period of time, such as 1 second, 1 minute or 1 hour or 1 day, such as wherein more than 5 instructions addressing assets which are not subject to control via the private network are received within 1 second,
A number of instructions, such as 2 or 6 or 11 or 101 or 1001, not belonging to a predetermined set of instructions and received at the external digital storage device exceeds a third predetermined number, such as 1 or 5 or 10 or 100 or 1000, of instructions within a third predetermined period of time, such as 1 second, 1 minute or 1 hour or 1 day, such as wherein more than 5 instructions not belonging to a predetermined set of instructions are received within 1 second,
An instruction received at the external digital storage device is not signed by a trusted source,
An signature of a trusted source on an instruction received at the external digital storage device is not validated (such as wherein this step of validation is carried out subsequent to said obtaining within the private network one or more instructions for controlling the power plant) by a device, such as a processor or a server, within the private network, such as if the signature has been created with a compromised and/or outdated certificate,
An instruction received at the external digital storage device belongs to a predetermined (strict) subset of instructions, such as instructions relating to an active power parameter, and the command of the instruction is outside a predefined set of commands, such as the predefined set of commands excluding commands outside eligible or appropriate (absolute or relative) values or rates of change of values for the predetermined subset of instructions, for the predetermined (strict) subset of instructions, such as issuing a command to adjust a parameter of active power to a value of 4 MW to a wind turbine generator with a rated power of 2 MW,
An instruction received at the external digital storage device 338 belongs to a predetermined subset of instructions and a command of the instruction relating to a rate of change of a value is outside a predefined range of rate of changes for the predetermined subset of instructions, such as if carrying out a command at the power plant implies that a set-point for active power is changed faster than a predetermined ramp-up and/or ramp-down time for the change to be executed,
A value of a command of an instruction of a certain instruction type received at the external digital storage device is outside a predefined value range for the instruction type, such as issuing a command to adjust a parameter of active power to a value of 4 MW to a wind turbine generator with a rated power of 2 MW,
A rate of change of a value of a parameter of a command of an instruction of a certain instruction type received at the external digital storage device is outside a defined rate range, such as wherein the defined rate range may be given in relative or absolute terms, for the instruction type, such as wherein the instruction belongs to a predetermined (strict) subset of instructions, such as if carrying out a command at the power plant implies that a set-point for active power is changed faster than a predetermined ramp-up and/or ramp-down time for the change to be executed,
An instruction would upon execution entail an absolute value of an operational parameter of the power plant exiting a first predetermined range, such as if carrying out a command at the power plant implies that an active power exceeds a rated active power,
An instruction would upon execution entail a relative change of a value of an operational parameter of the power plant exiting a second predetermined range, such as if a command implies that a set-point would be changed by more than 50% compared to the last set-point,
An instruction received at the external digital storage device is malformed, such as if an instruction holds extra data/values/text that is not needed for an instruction and/or a command,
A number, such as 2 or 6 or 11 or 101 or 1001, of non-executable instructions received at the external digital storage device exceeds a fourth predetermined number, such as 1 or 5 or 10 or 100 or 1000, of instructions within a fourth predetermined period of time, such as 1 second, 1 minute or 1 hour or 1 day, such as wherein more than 5 non-executable instructions are received within 1 second,
A number, such as 2 or 6 or 11 or 101 or 1001, of instructions addressing assets which are not connected to the private network and received at the external digital storage device exceeds a second predetermined number, such as 1 or 5 or 10 or 100 or 1000, of instructions within a fifth predetermined period of time such as 1 second, 1 minute or 1 hour or 1 day, such as wherein more than 5 instructions addressing assets which are not subject to control via the private network are received within 1 second.

‘Temporal distribution’ is understood as is common in the art, such as the relation between time of receipts of instructions and/or the actual time of receipt of the one or more instructions. The predetermined criterion relating to temporal distribution may, e.g., be fulfilled if instructions are received at too high or too low a rate, if one or more instructions are received within certain periods of time or if instructions are not received substantially equidistantly in time.

By ‘assets which are not subject to control via the private network’ may be understood assets which are not controllable via the private network due to being locked against control via the private network, not being controllable at all, not being connected to the private network, not being comprised within the power plant and/or not existing at all.

By non-executable instructions' may be understood instruction on assets which are not subject to control via the private network and/or instructions with commands which are not executable, e.g., due to the value being non-eligible for the addressed asset.

By ‘a predetermined set of instructions’ may for example be understood a permitted list or positive list of instructions, such as instructions with certain commands. The predetermined set of instructions may exclude types of instructions, e.g., instructions with commands on certain parameters (e.g., active power) addressing certain assets (e.g., a pitch actuator), and/or may exclude certain commands (e.g., commands relating to pitch angle) or certain values or ranges of values (e.g., commands regarding exceeding rated values).

By ‘a predetermined (strict) subset of instructions’ is understood a set of instructions, which may not (cf., ‘strict’) include all eligible instructions. An advantage of having a strict subset may be that it enables tailoring the excluded commands to specific assets and/or parameters, e.g., it may be expedient to set different limitation on rotational speed (RPM) for yawing, pitching and/or rotation of the rotor or a high sped shaft.

By ‘instruction type’ may be understood instructions relating to certain assets or parameters. Alternatively, the type of instruction may denote the nature of the instruction, e.g., if it comprises a Boolean (e.g. shutting an asset, such as a WTG, on/off), integer (e.g., shutting down 2 out of 5 WTGs) or floating point data type (e.g., adjusting active power) and/or if it relates to absolute (e.g., adjusting active power to 2 MW) or relative (e.g., curtailing active power to 50%) values. For example, it could be decided to exclude any change in values of non-Boolean parameters exceeding 50% within 1 second.

An instruction type may be defined by a predetermined (strict) subset of instructions.

By ‘execution’ may be understood that one or more devices within the private network carries out a command of an instruction.

The first, second, third, fourth and fifth predetermined number may each be selected arbitrarily and independently of each other, i.e., some or all may be equal to each other or they may all be different. The first, second, third, fourth and fifth predetermined period of time may each be selected arbitrarily and independently of each other, i.e., some or all may be equal to each other or they may all be different.

According to an embodiment the method is further comprising sending instructions from a source to the external digital storage device. The source may, for example, be a service centre, such as a service centre associated with a manufacturer of the one or more wind turbine generators. The source may, for example, be a transmission system operator (TSO).

According to an embodiment the method is further comprising: Execution at the power plant of the one or more obtained instructions for controlling the power plant, such as wherein said execution of said instructions implies physically controlling operation of one or more assets of the power plant based upon said obtained instructions. An advantage may be that an effect, such as a real-world, tangible effect (such as a change in power production, pitch angle and/or rotor speed), is achieved at the power plant.

According to an embodiment the power plant, such as one or more devices within the private network, is repeatedly, such as equidistantly in time, (and autonomously) sending power plant data to one or more recipients placed externally with respect to the private network, wherein power plant data comprises data regarding power plant operation and/or data regarding power plant conditions, wherein said sending is initiated from within the private network and independent with respect to requests originating externally with respect to the private network.

By ‘data regarding power plant operation’ may be understood data relating to controllable parameters, such as data relating to Supervisory Control And Data Acquisition (SCALA), for example data relating to electrical power, rotor speed, yaw position and/or pitch angle.

By ‘data regarding power plant conditions’ may be understood data relating to the conditions, such as conditions non-controllable (i.e., not being controllable) via the private network (such as conditions which are not controllable via the private network, but which might be controllable otherwise, e.g., via manual operation at the power plant), such as non-controllable conditions (such as conditions which can be considered generally non-controllable), such as data relating to environmental and/or meteorological conditions, such as weather, at the power plant.

According to a further embodiment the method comprises: Comparing the instructions received at the external digital storage device 338 with power plant data and verifying execution at the power plant of the instructions received at the external digital storage device 338. This may be beneficial for improving and/or securing proper operation of the power plant, such as with a view to optimize energy production and/or reduce or eliminate wear. For example, a source may provide to the external digital storage device an instruction and then subsequently, via said comparing, verify its execution at the power plant, which may in turn enable the source to take proper action in case the instruction has not been executed, e.g., providing to the external digital storage device the same (again) or another instruction and/or contacting employees at the power plant to request them to take relevant or even necessary precautions.

According to an embodiment the external digital storage device is in a secured network environment, such as a demilitarized zone (DMZ) or a perimeter network.

According to an embodiment the external digital storage device is in a demilitarized zone (DMZ). An advantage may be that it adds an additional layer of security to the private network, and might allow extra time to detect and address breaches before they would further penetrate into the private network. ‘Demilitarized zone’ (DMZ), which is also known as DMZ, perimeter network or screened subnet, is understood as is common in the art, such as a physical or logical subnetwork that contains and exposes a the private networks external-facing services to an external (entrusted) network, such as the public Internet. An external network node might access only what is exposed in the DMZ, while the rest of the private network might be firewalled. The DMZ may function as a small (such as relatively small with respect to the entire private network), isolated network positioned between, e.g., the Internet and the private network. DMZ may be seen as not belonging to either party bordering it.

According to a second aspect there is presented a system comprising:
A power plant comprising
   i. one or more wind turbine generators,
   ii. a private network,
An external digital storage device placed externally with respect to the private network,
   and wherein the system is arranged for carrying out a method according to the first aspect.

According to a third aspect there is presented a computer program product comprising instructions to cause the system of the second aspect to execute the steps of a method according to the first aspect. According to an embodiment a computer-readable medium is having stored thereon the computer program according to the third aspect. According to an embodiment a data carrier signal is carrying the computer program product according to the third aspect.

The first, second, and third of the present invention may each be combined with any of the other aspects. These and other aspects of the invention will be apparent from and elucidated with reference to the embodiments described hereinafter.

### BRIEF DESCRIPTION OF THE FIGURES

The method for obtaining within a private network of a power plant one or more instructions for controlling the power plant and the corresponding system and computer program product according to the invention will now be described in more detail with regard to the accompanying figures. The figures show one way of implementing the present invention and is not to be construed as being limiting to other possible embodiments falling within the scope of the attached claim set.

FIG. 1 shows a wind turbine,

FIG. 2 is a flow chart illustrating a method 210 for obtaining 218 within a private network 336 of a power plant 332 one or more instructions for controlling the power plant,

FIG. 3 shows an embodiment of a system 330 according to the second aspect.

### DETAILED DESCRIPTION OF AN EMBODIMENT

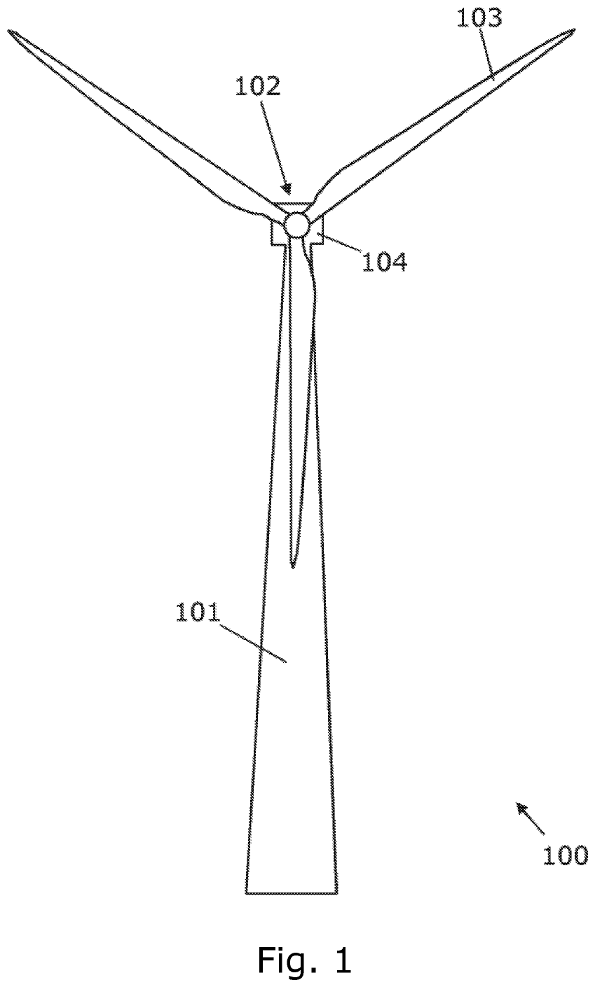

FIG. 1 shows a wind turbine 100 (which may also be referred to as a wind turbine generator (WTG)) comprising a tower 101 and a rotor 102 with at least one rotor blade 103, such as three blades. The rotor is connected to a nacelle 104 which is mounted on top of the tower 101 and being adapted to drive a generator situated inside the nacelle. The rotor 102 is rotatable by action of the wind. The wind induced rotational energy of the rotor blades 103 is transferred via a shaft to an electrical generator. Thus, the wind turbine 100 is capable of converting kinetic energy of the wind into mechanical energy by means of the rotor blades and, subsequently, into electric power by means of the generator. The generator may include a power converter for converting the generator AC power into a DC power and a power inverter for converting the DC power into an AC power to be injected into a utility grid. The generator is controllable to produce a power corresponding to a power request. The blades 103 can be pitched in order to alter the aerodynamic properties of the blades, e.g. in order to maximize uptake of the wind energy and to ensure that the rotor blades are not subjected to too large loads when strong winds are blowing. The blades are pitched by a pitch system with a pitch force system controlled by a pitch control system, where the pitch force system includes actuators for pitching the blades dependent on a pitch request from the pitch control system. The wind turbine may be an asset of a (wind) power plant and the parts of the wind turbine, such as one or more of the actuators for pitching the blades, may similarly be seen as (sub-)assets of the wind turbine and power plant.

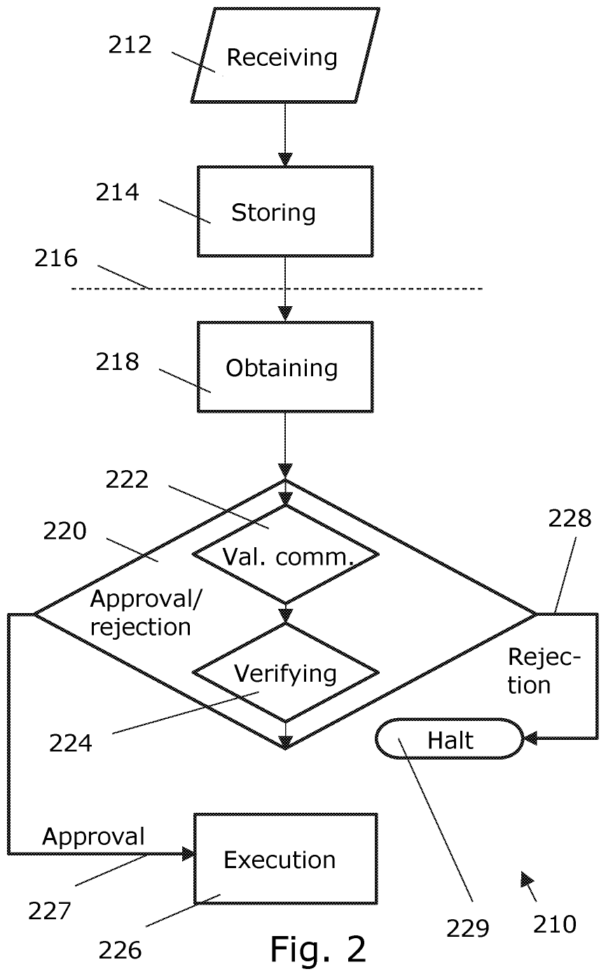

FIG. 2 is a flow chart illustrating a method 210 for obtaining 218 within a private network 336 of a power plant 332 one or more instructions for controlling the power plant, wherein the power plant is comprising one or more wind turbine generators 100, 334, and wherein the method is comprising:
Receiving 212 at an external digital storage device 338 placed externally with respect to the private network one or more instructions for controlling the power plant, wherein the method may be further comprising (not shown) sending instructions from a source to the external digital storage device 338 prior to said receiving 212,
Storing 214 the one or more instructions in a queue in the external digital storage device, such as wherein the external digital storage device may be a server and wherein said server is in a demilitarized zone 340 associated with or on the perimeter of the private network 336,
Obtaining 218 within the private network on request from within the private network one or more instructions for controlling the power plant, wherein said obtaining includes that one or more devices 342 within the private network are fetching from the queue in the external digital storage device said one or more instructions for controlling the power plant stored in the queue in the external digital storage device, wherein said fetching is independent with respect to events initiated externally with respect to the private network.

As indicated by dashed line 216 representing a border of the private network 336, an instruction is entering into the private network when—and only when—it is obtained on request from within the private network and upon independent fetching. The method schematically illustrated in FIG. 2 is further comprising subjecting within the private network the one or more instructions for controlling the power plant obtained within the private network to a step 220 of approval 227 or rejection 228, wherein the step of approval or rejection comprises validating 222 a command of the one or more instructions and wherein the step of approval or rejection comprises verifying 224 that the one or more instructions originate from a trusted source 344. As indicated in FIG. 2 said fetching is halted 229 if one or more predefined criteria are determined within the private network 336 to be fulfilled, wherein in the present case a predefined criterion is fulfilled in case of a rejection 227 due to lack of validation of a command and/or due to lack of verification. The method furthermore comprises execution (226) at the power plant 332 of the one or more obtained instructions for controlling the power plant, which in the present case is conditioned by approval 227 in the step 220 of approval or rejection. The entire process 210 may be carried out multiple times, such as repeated upon execution 226 or restarted subsequent to halting 229.

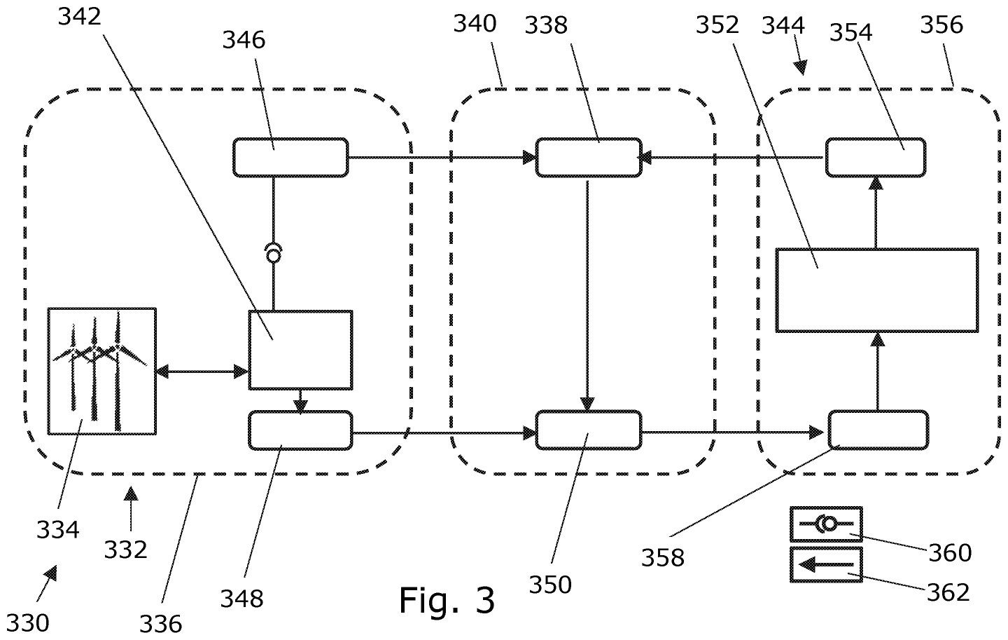

FIG. 3 shows a system 330 comprising:
A power plant 332 comprising
   i. one or more wind turbine generators 334
   ii. a private network 336,
An external digital storage device 338 placed externally with respect to the private network,
and wherein the system is arranged for carrying out a method 210 according to any one of the preceding claims.

FIG. 3 furthermore shows a source, such as a trusted source 344 of instructions, wherein the instructions are generated in and sent (internally within the trusted source network) from a data- and surveillance center 352 of the trusted source and wherein instructions are sent (externally out of the trusted source network) via and from an instruction collector 354 of the trusted source. The trusted source may be within a trusted source network 356 (as indicated by the dashed line), which may be, e.g., a local area network (LAN) of the trusted source or the public internet. The figure furthermore shows a demilitarized zone (DMZ) 340 (as indicated by the dashed line) on the perimeter of the private network 336 and wherein the demilitarized zone comprises the external digital storage device 338. The demilitarized zone 340 is considered to be external to the private network. The figure furthermore a private network 336 of a power plant with one or more wind turbine generators 334 and still further shows a device 342 within the private network 336 being arranged for obtaining 218 via fetching instructions for controlling the power plant from the external digital device 338, optionally via an access point 346 associated with the private network 336.

FIG. 3 furthermore shows a private network data relaying device 348 within the private network 336 being arranged for (receiving internally within the private network 336 power plant data, such as including data relating to Supervisory Control And Data Acquisition (SCADA), from the device 342 and for) repeatedly and autonomously sending power plant data to one or more recipients, which in the present system is a relaying recipient in form of an external data relaying device 350 placed externally with respect to the private network 336 in the demilitarized zone (340). In the depicted system 330 the external data relaying device 350 is arranged for relaying the power plant data to a final recipient and furthermore arranged for receiving and relaying instructions initially received at the external digital storage device 338 to the final recipient, which in the present case is the trusted source 344 which receives the power plant data via a source data relaying unit 358. This may be advantageous for enabling the final recipient, which may be a source, such as a trusted source, of instructions initially received at the external digital storage device, to compare the instructions received 212 at the external digital storage device 338 with power plant data and verifying execution at the power plant of these received instructions.

Each interface in FIG. 3 is either a public interface, cf., the public interface 360, or an inter-component interface, cf., the inter-component interface 362.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for obtaining within a private network of a power plant one or more instructions for controlling the power plant, wherein the power plant is comprising one or more wind turbine generators, and wherein the method comprises:
Receiving at an external digital storage device placed externally with respect to the private network one or more instructions for controlling the power plant;
Storing the one or more instructions in a queue in the external digital storage device; and
Obtaining within the private network on request from within the private network one or more instructions for controlling the power plant, wherein said obtaining includes that one or more devices within the private network are fetching from the queue in the external digital storage device said one or more instructions for controlling the power plant stored in the queue in the external digital storage device, wherein said fetching is independent with respect to events initiated externally with respect to the private network.

2. The method according to claim 1, further comprising:
approving or rejecting, within the private network, the one or more instructions for controlling the power plant obtained within the private network.

3. The method of claim 2, wherein the approving or rejecting comprises validating a command of the one or more instructions.

4. The method of claim 3, wherein an instruction is rejected due to a lack of validation if the command is not on a predefined list of commands.

5. The method of claim 2, wherein the approving or rejecting comprises verifying that the one or more instructions originate from a trusted source.

6. The method of claim 5, wherein an instruction is rejected due to a lack of verification if the source is not on a predefined list of trusted sources.

7. The method of claim 1, wherein said fetching is halted if one or more predefined criteria are determined within the private network to be fulfilled.

8. The method of claim 7, wherein the one or more predefined criteria are determined to be fulfilled if one or more of the following corresponding conditions are determined to be true:
rejecting, within the private network, the one or more instructions for controlling the power plant obtained within the private network;
rejecting, within the private network, the one or more instructions for controlling the power plant obtained within the private network for failure to verify that the one or more instructions originate from a trusted source;
determining that a temporal distribution of time of receipt of one or more instructions at the external digital storage device is not acceptable;
determining that a number of instructions received at the external digital storage device exceeds a first predetermined number of instructions within a first predetermined period of time;
determining that a number of instructions addressing assets which are not subject to control via the private network and received at the external digital storage device exceeds a second predetermined number of instructions within a second predetermined period of time;
determining that a number of instructions not belonging to a predetermined set of instructions and received at the external digital storage device exceeds a third predetermined number of instructions within a third predetermined period of time;
determining that an instruction received at the external digital storage device is not signed by a trusted source;
determining that an signature of a trusted source on an instruction received at the external digital storage device is not validated by a device within the private network;
determining that an instruction received at the external digital storage device belongs to a predetermined subset of instructions and a command of the instruction is outside a predefined set of commands for the predetermined subset of instructions;
determining that an instruction received at the external digital storage device belongs to a predetermined subset of instructions and a command of the instruction relating to a rate of change of a value is outside a predefined range of rate of changes for the predetermined subset of instructions;
determining that a value of a command of an instruction of a certain instruction type received at the external digital storage device is outside a predefined value range for the instruction type;
determining that a rate of change of a value of a parameter of a command of an instruction of a certain instruction type received at the external digital storage device is outside a defined rate range for the instruction type;
determining that an instruction would upon execution entail an absolute value of an operational parameter of the power plant exiting a first predetermined range;
determining that an instruction would upon execution entail a relative change of a value of an operational parameter of the power plant exiting a second predetermined range;
determining that an instruction received at the external digital storage device is malformed;
determining that a number of non-executable instructions received at the external digital storage device exceeds a fourth predetermined number of instructions within a fourth predetermined period of time; and
determining that a number of instructions addressing assets which are not connected to the private network and received at the external digital storage device exceeds a fifth predetermined number of instructions within a fifth predetermined period of time.

9. The method of claim 1, wherein the method further comprises sending instructions from a source to the external digital storage device.

10. The method of claim 1, wherein the method further comprises:
executing at the power plant of the one or more obtained instructions for controlling the power plant.

11. The method of claim 1, wherein the power plant is repeatedly sending power plant data to one or more recipients placed externally with respect to the private network, wherein power plant data comprises data regarding power plant operation and/or data regarding power plant conditions, wherein said sending is initiated from within the private network and independent with respect to requests originating externally with respect to the private network.

12. The method of claim 11, wherein the method comprises:
Comparing the instructions received at the external digital storage device with power plant data and verifying execution at the power plant of the instructions received at the external digital storage device.

13. The method of claim 1, wherein the external digital storage device is in a demilitarized zone.

14. A system comprising:
A power plant comprising:
one or more wind turbine generators; and
a private network; and
An external digital storage device placed externally with respect to the private network,
and wherein the system is configured to perform an operation, comprising:
receiving, at an external digital storage device placed externally with respect to the private network, one or more instructions for controlling the power plant;
storing the one or more instructions in a queue in the external digital storage device; and
obtaining within the private network on request from within the private network one or more instructions for controlling the power plant, wherein said obtaining includes that one or more devices within the private network are fetching from the queue in the external digital storage device said one or more instructions for controlling the power plant stored in the queue in the external digital storage device, wherein said fetching is independent with respect to events initiated externally with respect to the private network.

15. (canceled)

16. The system according to claim 15, further comprising:
approving or rejecting, within the private network, the one or more instructions for controlling the power plant obtained within the private network.

17. The system according to claim 16, wherein the approving or rejecting comprises validating a command of the one or more instructions.

18. The system according to claim 17, wherein an instruction is rejected due to a lack of validation if the command is not on a predefined list of commands.

19. The system according to claim 16, wherein the approving or rejecting comprises verifying that the one or more instructions originate from a trusted source.

20. A computer program product comprising instructions which, when executed by one or more processors, perform an operation of obtaining within a private network of a power plant one or more instructions for controlling the power plant, wherein the power plant comprises one or more wind turbine generators; the operation, comprising:
receiving, at an external digital storage device placed externally with respect to the private network, one or more instructions for controlling the power plant;
storing the one or more instructions in a queue in the external digital storage device; and
obtaining within the private network on request from within the private network one or more instructions for controlling the power plant, wherein said obtaining includes that one or more devices within the private network are fetching from the queue in the external digital storage device said one or more instructions for controlling the power plant stored in the queue in the external digital storage device, wherein said fetching is independent with respect to events initiated externally with respect to the private network.
